(19) United States
(12) Patent Application Publication
(10) Pub. No.: US 2005/0042387 A1
(43) Pub. Date: Feb. 24, 2005

(54) Filament coating process and apparatus

(75) Inventor: William V. Dower, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/645,021

(22) Filed: Aug. 21, 2003

(51) Int. Cl. B05D 1/18; B05D 5/06

(52) U.S. Cl. 427/553; 427/434.6; 427/163.2; 427/532; 118/400

(57) ABSTRACT

A process and apparatus for coating a filament. The apparatus comprises a reservoir of a photopolymerizable liquid composition, an exposure source emitting actinic radiation to cure the liquid composition, a lens to focus radiation from the exposure source in a plane adjacent to the surface of the liquid composition and a filament holding fixture for immersing at least a portion of the filament at a depth in the liquid composition. Upon exposing the liquid composition adjacent to the portion of the filament to actinic radiation from the exposure source, the liquid composition cures to provide an immersion-coated portion of filament that is covered by a cured layer of the liquid composition.

### BACKGROUND OF THE INVENTION

1. Field of the Invention

The invention relates to a process for applying a coating composition to portions of filaments, particularly optical fibers. More particularly the present invention provides a process for recoating a stripped portion of an optical fiber immersed in a photocurable coating composition that photocures during exposure to actinic radiation to form a layer of cured resin on the surface of the stripped portion of optical fiber.

2. Description of the Related Art

Interconnection of fiber optic networks requires high precision devices in the form of optical connectors and spliced connections that join optical fibers to peripheral equipment and other optical fibers with minimal attenuation of signal strength. Fiber optic networks may include special features formed in selected, relatively short lengths of optical fiber. The process of introducing special features such as Bragg gratings into an optical fiber may include a number of steps requiring handling of relatively short lengths of optical fiber during a series of manufacturing operations. An optical fiber typically requires removal of protective coatings to facilitate optical fiber splicing or change of the physical characteristics of the optical fiber to include e.g. a refractive index grating such as a Bragg grating.

After formation of a fusion splice or refractive index grating, the length of optical fiber including the spliced or modified portion is a bare portion that requires recoating by application of a protective coating. It is possible to use in-mold recoating, spray recoating or an extrusion die coating process to recoat a previously stripped portion of an optical fiber. Injection die coating refers herein to conventional in-mold die recoating. Spray recoating uses multiple passes of an optical fiber between a spray head and a radiation curing source. The extrusion recoating process uses a split die that may be positioned around an optical fiber for application of a curable coating composition around the circumference of the fiber as the extrusion head traverses the length of an uncoated fiber portion. Preferably the die head includes a radiation source and the extruded coating cures by exposure to the radiation source. This allows application of recoating material followed immediately by curing.

A recoating mold, described in U.S. Pat. No. 4,410,561, provides a coated optical fiber using a split mold die structure. The size and design of a cavity formed by the closed mold provides space that becomes filled during injection of curable, protective, fluid recoating compositions. Shrinkage of recoat material during cure may cause air entrapment. It is desirable to avoid entrapment of air inside the mold since this could lead to a defective recoated fiber section. Complete filling of a mold cavity may involve intentional application of pressure. U.S. Pat. No. 5,022,735 uses a screw type plunger to pressurize recoating fluid injected into a conventional recoating mold. Some recoating molds include curing means to provide finished recoated sections of optical fibers. U.S. Pat. No. 4,662,307, for example, uses a split mold including an injection port and UV light port through which light passes to cure recoating compositions. The curing process requires multiple light sources.

Application of coatings to an optical fiber drawn from a pre-form typically places the emerging fiber in a vertical orientation. As it travels downward, the fiber may pass through a reservoir of coating fluid before exiting through a coating die having an orifice sized to the desired external diameter of the coated fiber. A study, reported in Electronics Letters Vol. 34, No. 12, Jun. 11, 1998, pp. 1249-1250, investigated a split die recoating process to apply a solution of polyimide to a bare portion of an optical fiber. The process involved drawing a fiber through the fluid filled split die, then driving off solvent at 70° C. followed by baking the polyimide recoated section at 300° C.

It is possible to apply such processes to recoating bare sections of optical fiber including a Bragg grating, as taught in U.S. Pat. No. 6,069,988. Upon exit from the coating die, the fiber moves past a source of curing radiation. The curing radiation differs from the radiation used for writing the Bragg grating so as not to destroy or change the characteristics of the grating.

Air entrapment may occur as an optical fiber enters coating fluid in a coating die of the type described in U.S. Pat. No. 6,069,988. Such air entrapment is undesirable and may be overcome according to the method described in Japanese Patent Publication JP 9-166718, which describes a preparatory step of immersion of a portion of stripped optical fiber, in horizontal orientation, in a photopolymerizable coating composition. The stripped portion of optical fiber includes coated boundaries that the coating composition fills during immersion. Preparatory treatment of the stripped portion of optical fiber reduces air entrapment and bubble formation during subsequent recoating by drawing the optical fiber through a pool of the same coating composition contained in a conventional coating die. Exposure to suitable radiation hardens the coating after the recoated optical fiber passes through the coating die.

Japanese Patents JP 60-122754 and JP 61-40846 and, for example, U.S. Pat. No. 6,532,327 include description of spray recoating processes for applying protective polymeric coatings to optical fibers. Coverage of the full circumference of the optical fiber uses multiple spray heads or special devices including spray containment shrouds or spray-deflecting air knives or the like.

Regardless of the number of processes available for coating and recoating the surfaces of filaments, such as optical fibers, there is a need for further improvement to overcome existing problems including incomplete surface coating and air bubble entrapment.

### SUMMARY OF THE INVENTION

The present invention provides desired process improvements during coating and recoating lengths of optical fiber. In a typical application, a recoating process replaces protective coating over the surface of a previously stripped length of an optical fiber. According to the present invention the recoating process includes immersion of the stripped length of optical fiber in a quantity of photopolymerizable recoat liquid held in a containment vessel. Correct positioning of the stripped length of optical fiber in the photopolymerizable recoat liquid, followed by controlled exposure to a suitable source of radiation, causes a layer of cured polymer to accumulate around an exposed portion of the immersed and exposed length of optical fiber.

A coating process according to the present invention provides a number of advantages over other methods for coating or recoating optical fibers. The advantages include high-speed throughput of coatings using a non-contact process for custom configuration of coating geometry, including coating radius selection and predetermined positioning of gaps in the coating. An apparatus according to the present invention provides an improvement over conventional recoating processes since it does not use a fluid-containing mold or die that requires cleaning between each recoating operation.

Coating appearance advantages include the substantial reduction of bubbles, mold marks, excess coating, and other defects associated with conventional processes. The use of polymerizing radiation also provides control over the extent of polymerization, which restricts coating as desired to only selected exposed portions along the length of the processed optical fiber. Use of a scanned laser as an exposure source allows relatively rapid adjustment of exposure conditions to produce changes in the geometry of applied coatings without reconfiguring the processing equipment significantly. Robot-controlled laser scanning involves automatic positioning of a single optical fiber or several optical fibers in a liquid, photopolymerizable coating composition followed by controlled exposure to radiation that cures the coating over a portion of the optical fibers, which may be processed either simultaneously or sequentially.

Preparation for immersion coating or recoating according to the present invention involves two main considerations. A first consideration involves component positioning and a second consideration addresses the relationship between the optical density of a coating composition and the actinic radiation used to promote photopolymerization. Component positioning affects alignment of the radiation source and a lens to an optical fiber having a portion immersed in a prescribed orientation in a reservoir of photopolymerizable coating composition. Preferably the radiation source has a horizontal orientation and may be adjusted to low intensities to facilitate focusing adjustment. When using a high intensity tungsten filament lamp, correct alignment of the radiation source with a planoconvex cylindrical lens, possibly a Fresnel lens with or without masks, provides an image, of the filament of the radiation source, as a horizontal line of minimum diameter. An exemplary alignment places a tungsten filament radiation source approximately 54 cm from the lens, which has a separation of about 7.5 cm from the focused image of the filament.

After setting up the illumination equipment, a fixture provides support, just below the focal plane of the focused image, for an optical fiber portion that requires application of coating composition. Adjustment of the optical fiber axis to the image of the illumination source allows coating of subsequent optical fibers without realignment, provided the fixture is reasonably dependable and not subject to inadvertent perturbations. Upon completing the relative positioning of the illumination equipment and an optical fiber, a suitably positioned reservoir of photopolymerizable, liquid coating composition places the coatable portion of optical fiber at a controlled distance beneath the liquid surface. Providing the optical fiber is not disturbed during positioning of the reservoir of photopolymerizable liquid, the controlled distance represents the thickness of coating applied to the surface of an optical fiber facing the illumination equipment. As an alternative, a portion of an optical fiber may be slowly immersed in the coating composition during exposure to suitable radiation to increase the viscosity of the coating to a gelled, cured condition by photopolymerization of the coating composition.

Controlled exposure of a photopolymerizable composition, sufficient to effect cure of the photopolymer, applies a layer of cured polymer to the surface of an optical fiber. An exemplary exposure sequence includes energizing the radiation source to provide radiant energy of about 2J/cm² while immersing the exposed portion of an optical fiber at the controlled depth in the coating fluid. After moving the fluid reservoir clear of the optical fiber, exposure of the optical fiber portion continues for about one second at substantially constant radiation intensity. At this point in the coating process, uncured coating material may be removed from the optical fiber after extinguishing the illumination source. Removal of uncured coating may use a flexible blade shaped to include an inverted U corresponding to the approximate prescribed diameter of the recoated optical fiber portion. Further curing of the applied coating composition includes flood illumination of the newly coated portion of the optical fiber. While immersion coating according to the present invention uses an optical fiber as an exemplary filament, it will appreciated by one of ordinary skill in the art that the process may be applied generally to filamentary substrates. Further reference to immersion recoating herein should not be interpreted as limiting the process of the present invention to stripped portions of optical fibers since the amount of filament coated may not be limited to only a stripped portion of optical fiber. The process according to the present invention may be used in a variety of applications for coating a range of filaments, applying multiple layers to filaments and, as exemplified herein, for recoating stripped optical fibers to re-create a protective recoated portion that may cover only a bare portion of an optical fiber but also may extend over portions of the original optical fiber coating or buffer on either side of the previously bare portion.

More particularly, the present invention provides a process for coating a filament comprising the steps of providing a photopolymerizable liquid composition and immersing a portion of a filament to a depth in the liquid composition. After exposing the liquid composition adjacent the portion of filament to actinic radiation from an exposure source, the liquid composition cures to provide an immersion-coated portion having a cured layer of the liquid composition applied to the portion.

The present invention also provides an apparatus for coating a filament. The apparatus comprises a reservoir of a photopolymerizable liquid composition having a surface in the path of an exposure source emitting actinic radiation to cure the liquid composition. A lens located between the surface and the exposure source focuses radiation from the exposure source in a plane adjacent to the surface of the liquid composition. The apparatus includes a filament holding fixture for immersing at least a portion of the filament at a depth in the liquid composition. The apparatus provides a cured coating by exposing the liquid composition to the exposure source such that the cured coating covers the at least a portion of filament immersed by the filament holding fixture in the liquid composition.

Definitions

Terms used herein have the meanings indicated as follows:

The term “filament” herein refers generally to a fiber structure, preferably comprising a glass filament. An optical fiber is representative of a glass filament according to the present invention.

The terms “bare fiber,” or “bare fiber portion,” or “stripped fiber,” or phrases relating to such terms refer herein to the portion of an optical fiber from which protective coating has been removed to expose the surface of the optical fiber.

Terms including “photopolymerizable coating composition,” “photopolymerizable liquid composition” and “photopolymerizable recoat liquid” and the like refer to photosensitive coating materials in a fluid state that cure by crosslinking when exposed to actinic radiation in an appropriate range of the electromagnetic spectrum.

The term “focal plane” refers to a spatial area or plane containing a focused image derived from an exposure source. An exemplary exposure source including a high intensity tungsten filament lamp provides a “focal line” corresponding to an image of the glowing tungsten filament focused in the focal plane after radiation from the lamp passes through a lens in the radiation path.

The term “optical density” (OD) is well known as a wavelength dependent expression of the transmittance given as log₁₀ (1/T) where T is the transmittance. Optical density may be considered as the degree to which a refractive medium retards transmitted rays of light, i.e. the higher the optical density, the lower the transmittance. Ten times optical density corresponds to a transmission loss expressed in decibels, e.g. an optical density of 0.3 corresponds to a transmission loss of 3 dB.

The term “aspect ratio” refers herein to the deviation from circular of the cross section and circumference of a filament coated according to the present invention. A coated filament or coated optical fiber of circular cross section has an aspect ratio of 1.0, which is the ratio for orthogonal diametric axes of equal length. Values of aspect ratio between about 1.1 and about 1.5 indicate relatively small deviation from circular cross section.

### BRIEF DESCRIPTION OF THE DRAWINGS

Notwithstanding any other forms, which may fall within the scope of the present invention, preferred forms of the invention will now be described, by way of example only, with reference to the accompanying drawings in which:

FIG. 1 is a schematic representation of a cross-sectional view showing equipment according to the present invention for immersion coating fibers including optical fibers.

FIG. 2 is a schematic representation of a cross sectional view showing coating equipment according to the present invention including a filament holding fixture used to position a filament below the surface of a liquid coating composition.

FIG. 3 is a schematic representation showing the structure of an exemplary filament holding plate, which is a part of a filament holding fixture according to the present invention.

### DETAILED DESCRIPTION OF THE INVENTION

The present invention provides a process that allows coating of stripped lengths of optical fiber. While adaptable to a variety of coating applications, the process is particularly useful for replacing protective coatings earlier removed from an optical fiber to allow modification of the optical fiber to produce, for example, a fiber optic refractive index grating. Replacement of a protective coating on the surface of an optical fiber is generally referred to as recoating an optical fiber. A recoating process according to the present invention involves locating a previously stripped length of an optical fiber in a quantity of polymerizable recoat liquid held in a suitable containment vessel. Suitable vessels present a relatively large surface area of polymerizable recoat liquid to facilitate immersion and accurate positioning of the stripped length of optical fiber relative to an exposure device. A suitable exposure device emits radiation that cures the recoat liquid around the fiber during immersion. Correct positioning of the stripped length of optical fiber below the surface of the polymerizable recoat liquid, during exposure to a controlled beam of radiation, causes a layer of cured polymer to accumulate around the immersed length of optical fiber.

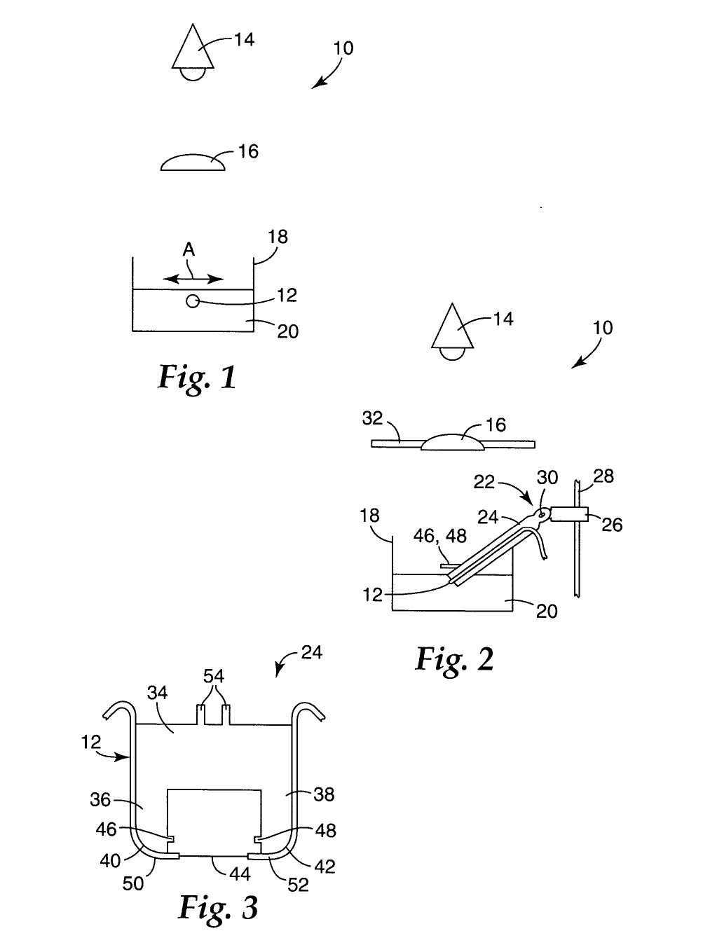

During the following discussion it should be recognized that the figures are not necessarily to scale, and some features may be exaggerated or minimized to show details of particular components. Referring now to the figures wherein like numbers refer to like parts throughout the several views, FIG. 1 provides a schematic representation of a cross-sectional view showing equipment (10) according to the present invention for immersion coating a fiber (12). The equipment includes an exposure source (14), a focusing lens (16) and a reservoir (18) of a photopolymerizable liquid composition (20) arranged to focus radiant energy from the exposure source (14) in a plane (A) (designated the focal plane) close to a fiber (12) immersed just below the surface of the photopolymerizable liquid composition (20) in the reservoir container (18). An exemplary process, according to the present invention, uses an incandescent lamp as an exposure source (14) that includes a lamp filament. In this case, relative positioning of the focusing lens (16) and the exposure source (14) produces a well-defined image or filament line focused in the focal plane (A). Photopolymerizable coating compositions (20) exposed to radiant energy concentrated in the focal plane (A) will cure over the surface of a fiber (12) immersed just below the surface of the coating liquid (20). The depth of immersion of the fiber (12) is a response-effective variable for control of the thickness of the layer of coating (20) that cures during illumination by the exposure source (14).

FIG. 2 is a schematic representation clarifying the use of a fixture (22) for placement of a filament, in this case an optical fiber (12), just below the surface of the coating composition (20). The fixture (22) includes a plate (24) extending from a clamp (26) attached to a support rod (28). Connection between the plate (24) and the clamp (26) may take any of a number of known forms provided that it is possible to set the plate (24) at an angle to the support rod (28) that allows liquid coating composition (20) to cover the edge of the plate (24) and a portion of the filament (12). As indicated in FIG. 2, the clamp (26) may be adjustable for height depending on its position on the support rod (28). Also the connection between the clamp (26) and plate (24) may be a hinge (30), as illustrated in the figure for facilitating angular adjustment of the plate (24) relative to the clamp (26) and the support (28).

The equipment (10) for immersion coating of filaments (12) according to the present invention may include a shroud (32) around the focusing lens (16) to prevent extraneous radiation from reaching the photopolymerizable coating composition (20).

FIG. 3 provides a plan view of a plate (24), also referred to herein as a filament holding plate, showing further detail of the plate's (24) structure. The filament holding plate (24) includes a base (34) having a first arm (36) and a second arm (38) attached to the base giving the plate (24), as illustrated, a generally inverted U shape. It will be appreciated that the plate (24) may be formed to a different shape without departing from the scope of the present invention.

The outer edge of each of the first arm (36) and the second arm (38) includes a rounded guide surface (40, 42) for positioning a filament (12) to hold it during coating of a section of filament (44) held between the first arm (36) and second (38) arm. On the inner edge of each arm (36, 38) a masking flange (46, 48) shields regions (50, 52) of the filament (12), on either side of the optical fiber section (44) to be coated, to prevent undesired application of cured coating to those regions (50, 52).

Although not intended to be limiting, FIG. 2 shows a hinge (30) as an exemplary device to accomplish pivoting between the two parts (24, 28). Pivotal movement can be made possible by attachment of the filament holding plate (24) to the clamp (26) using a two-part bracket (54) attached to the base (34) as a component of the hinge (30).

In one example of the recoat process according to the present invention, a scanned laser, of the type used in stereolithography, provides a suitable radiation source for photocuring the photopolymer. Other exposure devices could include a system of masks and lenses coupled with a relatively diffuse source of radiation that may be selected from readily available radiation sources that include a mercury vapor bulb, a germicidal lamp, a fluorescent tube, a high intensity incandescent lamp and the like.

Accurate placement of photopolymerized recoat material around stripped lengths of the optical fiber occurs by control of several variables including the light source, the position of the immersed length of fiber relative to the light source and the optical properties of the photopolymerizable liquid material. Using a computer controlled laser as the radiation source, the stripped length of an optical fiber may be recoated using a scanned beam of radiation to form the cured polymer layer. Coating conditions may be changed, for example, by adjusting the beam intensity, scanning rate and duration of exposure. Suitable selection of exposure conditions could produce recoated lengths of optical fibers covered by a layer of cured polymer having a radius close to that of the original optical fiber coating.

The choice of recoat composition depends upon the properties desired for the recoated fiber. Unlike conventional recoating techniques, which are viscosity dependent, the present invention accommodates a comparatively wide range of coating viscosities. In common with conventional recoat techniques, the present invention uses recoat compositions having suitable photosensitivity and optical density to provide a substantially symmetrical cured layer of coating around a recoated portion of an optical fiber. A coating composition using an initiator selection and concentration that provides a relatively high optical density will allow a disproportionate amount of the actinic radiation to be absorbed at, or just below, the surface of the photopolymerizable composition closest to the exposure source. Profiles of recoated optical fiber portions using such coating compositions tend to have a broad, flattened geometry varying in thickness around the circumference of the optical fiber and may have exposed glass on the underside. This indicates that high levels of radiation absorption limit the depth of cure of photopolymerizable liquids to relatively shallow regions close to the surface of the curing fluid. In contrast, coating compositions of relatively low optical density allow radiation to penetrate deeper into a photopolymerizable fluid to produce cured coatings having a relatively thin coating on the filament surface facing the exposure source and a relatively thick coating on the surface most deeply immersed in the coating fluid.

Embodiments of recoated optical fibers according to the present invention include a photopolymerized layer of substantially uniform thickness around the circumference of a recoated optical fiber. A coating of uniform thickness would have a circular cross section, having an aspect ratio of 1.0, achievable by adjustment of initiator and other component concentrations of a photopolymerizable coating composition. Adjustment of concentrations and associated coating properties yielded coating profiles having an aspect ratio, as defined herein, in a range about 1.15 and about 1.35. This indicates control of coating profile to an aspect ratio less than about 1.4.

An exemplary recoated optical fiber has a diameter of about 300 μm. A range of photopolymerizable coating compositions may be applied using the coating apparatus according to the present invention. Suitable coating compositions include commercially available formulations, for example DESOTECH 950-200 (available from DSM Desotech of Heerlen, The Netherlands) to which has been added about 1.0% to about 2.0% of a photoinitiator exemplified by IRGACURE 2020, DAROCURE 1173 (available from Ciba, Basil, CH) and other initiators mentioned for example in U.S. Pat. Nos. 6,331,080, 6,151,433 and 6,085,004. The amount of initiator depends upon the intensity of the exposure source, the rate of cure and the preferred geometry of the cured coating. An alternative exemplary photopolymerizable liquid coating composition comprises 78.4 wt % EBECRYL 230 (available from UCB Radcure, Drogenbos, Belgium); 19.0 wt % SR 395 (available from Sartomer, Exton, Pa.) and 2.6 wt % IRGACURE 2020.

As indicated above, control of the position of a length of optical fiber and selection of exposure conditions leads to accurate placement of a uniform layer of cured recoat material around the optical fiber provided that the recoat liquid has an optical density suitable for use with a selected exposure source. Positioning of a stripped length of optical fiber depends on a number of factors including alignment of the exposure source mounted horizontally relative to a lens, the fiber and the reservoir of liquid coating material. One example uses a 300W type T bulb (high intensity tungsten/halogen/quartz flood lamp available from Home Depot Inc.) with a small diameter filament approximately five centimeters (two inches) long. Replacement of ultraviolet radiation-absorbing safety glass with a plate that is transparent to ultraviolet radiation produces a light source that emits ultraviolet radiation. A variable power supply provides energy to the lamp of the exposure source at voltages up to about 120 volts. Lower voltage settings provide a comfortable light intensity for adjusting the focus of the lamp.

The lens, a 5.0 cm×5.0 cm planoconvex cylindrical fused silica lens (available from CVI of Albequrque, N. Mex., as part no. SCX 50.08-38.1-UV), was mounted in a multi axis adjustable mount (available from Newport, Irvine, Calif.). The lamp and the lens were aligned to provide an image of the lamp filament as a horizontal line with a minimum diameter. The lens was shrouded so that the light from the lamp would not illuminate the space below the lens unless it had passed through the lens. The distance from the lamp to the lens was about 50.0 cm to about 60.0 cm, and from the lens to the image was about 7.0 cm to about 10.0 cm.

A fixture was fabricated to hold the fiber to be recoated just below the focal plane of the image of the filament. A horizontal white screen may be placed about 2.5 cm (one inch) below the fiber, to confirm uniform intensity of the image of the filament below the length of optical fiber to be coated. Coating of subsequent fibers then proceeds without realigning the fixture and illumination source, provided the fixture is reasonably stable and not disturbed.

Recoat liquid, held in a recoat reservoir, can be positioned to surround the optical fiber without disturbing its location. Due to the photosensitivity of coating compositions according to the present invention, filling and positioning of the recoat reservoir proceeds under subdued lighting. In one embodiment of the present invention, the surface of the recoat liquid covers an immersed portion of optical fiber at a controlled distance from about 0.1 mm to about 0.2 mm. As mentioned above the depth of optical fiber immersion appears to be a response effective variable for the thickness of a cured coating applied to the surface of the optical fiber. Some other aspects of the present invention that influence the characteristics of a cured coating include initiator and other component concentrations as well as the intensity of exposure, the numerical aperture and the optical density of the coating fluid.

An exemplary procedure for applying a coating to a portion of optical fiber included illumination of the immersed optical fiber portion for about 5.0 seconds to a lamp operating at an applied voltage of 100 volts to emit radiant energy of about 2J/cm². Exposure to the light source continued for about one more second as the reservoir was repositioned to separate the optical fiber portion from the recoating composition. Separation of the optical fiber portion from the recoating composition usually involves lowering the reservoir away from the optical fiber. The light was then extinguished during removal of uncured recoating liquid by gentle wiping of the underside of the recoated optical fiber using a soft rubber squeegee. If desired, the optical fiber could be left with sections of uncoated glass to facilitate subsequent processing including surface modification such as application of metal and metal oxide coatings, for example. Final curing of applied recoating composition was achieved by flood-illumination, optionally under an inert gas atmosphere. The photocured layer of coating material may be swabbed by gently wiping with a clean room, lint-free cloth moistened in a variety of solvents including acetone, methanol, isopropanol and the like.

An optional embodiment of the present invention includes an optical fiber holding fixture equipped with shrouds placed about 5.0 mm to about 10.0 mm above the un-stripped portion of an optical fiber. Suitable shroud positioning produces a shadow pattern adjustable to give uniform geometry across the transition at the boundary between the original coated optical fiber and portions recoated according to the process of the present invention.

As required, details of an apparatus and process for coating optical fibers are disclosed herein; however, it is to be understood that the disclosed embodiments are merely exemplary. Therefore, specific structural and functional details of the present invention are not to be interpreted as limiting, but merely as a basis for the claims and as a representative basis for teaching one skilled in the art to variously employ the present invention.

1. A process for coating a filament comprising the steps of:
providing a photopolymerizable liquid composition;
immersing a portion of a filament in a substantially horizontal orientation to a depth in said liquid composition; and
exposing said liquid composition adjacent said portion to actinic radiation from an exposure source to cure said liquid composition to provide an immersion coated portion having a cured layer of said liquid composition applied to said portion.

2. The process of claim 1, wherein the filament is an optical fiber.

3. The process of claim 2, wherein said portion is a bare portion of the optical fiber.

4. The process of claim 1, further comprising adjusting said depth.

5. The process of claim 4, wherein said depth is from about 0.1 mm to about 0.2 mm.

6. The process of claim 1, wherein said exposing said liquid composition includes focusing radiation from said exposure source in a plane adjacent to the surface of said liquid composition.

7. The process of claim 6, wherein said plane is a substantially horizontal plane.

8. The process of claim 6, wherein said focusing radiation uses a lens located between said exposure source and said plane.

9. The process of claim 1, wherein said immersing a portion uses a filament holding fixture to locate said bare portion at said depth in said liquid composition.

10. The process of claim 1, wherein said immersion coated portion has a substantially circular cross section.

11. The process of claim 10, wherein said substantially circular cross section has an aspect ratio less than about 1.4.

12. An apparatus for coating a filament, said apparatus comprising:
a reservoir of a photopolymerizable liquid composition having a surface;
an exposure source emitting actinic radiation to cure said liquid composition;
a lens located between said surface and said exposure source to focus radiation from said exposure source in a plane proximate to said surface of said liquid composition; and
a filament holding fixture for immersing at least a portion of the filament at a depth in said liquid composition, said apparatus providing a cured coating by exposing said liquid composition to said exposure source, said cured coating covering said at least a portion immersed by said filament holding fixture in said liquid composition.

13. The apparatus of claim 12, wherein the filament is an optical fiber.

14. The apparatus of claim 13, wherein said portion is a bare portion of the optical fiber.

15. The apparatus of claim 13, wherein said optical fiber has a substantially horizontal orientation when immersed by said filament holding fixture in said liquid composition.

16. The apparatus of claim 12, wherein said plane is a substantially horizontal plane.

17. The process of claim 12, wherein said depth is from about 0.1 mm to about 0.2 mm.

18. The apparatus of claim 12, wherein said filament holding fixture comprises a filament holding plate attached to a clamp by a pivot, said clamp slidingly engaging a support rod for adjusting the height of the filament holding plate and the clamp relative to said surface of said liquid composition.

19. The apparatus of claim 18, wherein said filament holding plate comprises at least one masking flange to provide demarcation of a section of filament to be coated.
